(19) United States
(12) Patent Application Publication
(10) Pub. No.: US 2011/0241556 A1
(43) Pub. Date: Oct. 6, 2011

(54) METHOD OF CONTROLLING A FLUORESCENT LAMP, A CONTROLLER AND A FLUORESCENT LAMP

(75) Inventors: Peter Hubertus Franciscus Deurenberg, s-Hertogenbosch (NL); Wilhelmus Hinderikus Maria Langeslag, Wijchen (NL); Henricus T. P. J. Van Elk, Ravenstein (NL); Dennis Jansen, Budel Schoot (NL)

(73) Assignee: NXP B.V., Eindhoven (NL)

(21) Appl. No.: 13/132,628

(22) PCT Filed: Dec. 10, 2009
(86) PCT No.: PCT/IB09/55643

§ 371 Date: Jun. 3, 2011

(30) Foreign Application Priority Data
Dec. 10, 2008 (EP) 08105967.7
Jul. 3, 2009 (EP) 09161788.6

(51) Int. Cl. H05B 41/36; H05B 41/14

(52) U.S. Cl. 315/245; 315/307

(57) ABSTRACT

A method of controlling a Fluorescent Lamp (CFL) is disclosed, which enables the lamp to be dimmed during a quick-start mode in which the lamp current may be boosted. The method involves determining a boost value and a dimming value, and controlling the lamp power in dependence on the boost and dimming values. A dimming threshold may be set, below which (i.e. at dimmer output light levels) the boost function is disabled. Hysteresis may be included in the control, in order to avoid hopping between modes. A controller for use with a fluorescent lamp which is adapted to operate according to such a method and a fluorescent lamp using such a controller are also disclosed.

### FIELD OF THE INVENTION

This invention relates to methods of controlling fluorescent lamps, to controllers for fluorescent lamps, and to fluorescent lamps.

### BACKGROUND OF THE INVENTION

Fluorescent lamps, in the form of relatively long general lighting tubes, have been widely used for lighting applications since the 1930s. However, their size and properties—in particular the characteristic colour, or colour temperature—have resulted in their not being widely used in the domestic environment.

Fluorescent lamps rely on the emission of electrons from an electrode, to provide the electrons to ionise the gas within the tube. Since electron emission is much more efficient from a hot electrode, fluorescent lamps often include a filament as the electrode. They thus require two terminals or pins to the electrode, in order to pass a current through the filament to heat it, in addition to the electron emission current. Partly due to their relatively high operational efficiency, fluorescent lamps have been developed for use in a wide range of supplementary applications. Many of these supplementary applications require the lamp to be small relative to the conventional and well-known fluorescence general lighting tube. In part to satisfy the requirement for a small device, cold cathode fluorescent lamps (CCFL) have been developed. CCFL lamps are characterised in that they only have a single terminal pin to the emission electrode. The electrode does not consist of a filament, but a simple bar: in order to achieve a high emission temperature and thus improve efficiency, the electrode may be arranged to act in a self-heating mode. CCFL lamps tend to be used in applications such as backlighting for LCD displays.

Another development of fluorescent lamp technology has been directed towards compact fluorescent lamps (CFL). Compact fluorescent lamps often have integrated controller or ballast, and so an alternative terminology “integrated compact fluorescent lamp”, (CFL-i) is also used. Due to the world-wide increasing focus on energy consumption, more and more attention is paid to integrated Compact Fluorescent Lamps. Hereinafter in this document, the term CFL will be used inclusively to include CFL-i.

Such lamps have been developed with the general aim of replacing conventional incandescent bulbs (Edison lamp). Fluorescent lamps such as CFL lamps have an inherent efficiency advantage compared with incandescent light sources, being typically around five times more efficient. However, although these lamps have been available for over twenty years, they have not yet achieved particularly high market penetration. Partly this can be attributed to sub-optimal marketing, partly due to their higher price but also partly due to their properties.

Due to the worldwide focus on energy consumption, together with political moves in some countries towards banning traditional incandescent light-bulbs, it is anticipated that commercial interest in and market volumes for CFL lamps will increase. Furthermore, some of the technical barriers against widespread uptake of CFL lamps have been solved in recent years. For example, although the original CFL lamps were very large, modern CFL lamps can either match or almost match the regular incandescent light bulbs. A further example of the technological developments which will increase the uptake of CFL lamps is the ability to dim the lamps. Lamp dimming is typically achieved either by phase cut, in which the sinusoidal ac mains supply voltage or current is interrupted (that is, set to zero) during a part of each cycle, or alternatively, step dimming is used, in which the average current level supplied to the lamp is reduced (by a discrete “step”).

Another barrier to uptake, which has only partially been resolved to date, is that of the slow light increase which is observed when turning on a cold lamp. The problem may be addressed to some extent by temporarily increasing the lamp current, in a “quick start” mode. In a known quick start mode, the lamp current feedback system is temporarily disabled, and operation is forced at a fixed frequency, which is lower than normal operating frequencies. As a result of low frequency operation, the lamp current is higher, resulting in faster warm-up of the lamp. After a predetermined period, when the light output has reached its normal operating level, the quick-start mode is terminated, the operating frequency increases, and the current returns to its nominal operating value.

In order to implement a quick-start approach, dimming is disabled during quick-start, to prevent operation instabilities due to the reduced frequency of operation. This is inconvenient to the user, since the undimmed light output towards the end of the quick-start period may be inconveniently or unacceptably high, as well as wasteful of energy. Further, it is difficult to determine accurately the period for which the quick-start should be applied, since it derives from leakage through several components.

There thus remains a desire for a method of controlling a fluorescent lamp which enables a quick-start, whilst retaining the benefits of dimming capability.

### SUMMARY OF THE INVENTION

It is an object of the invention to provide a method for controlling a fluorescent lamp, which enables a quick-start, whilst retaining the benefits of dimming capability.

According to the invention there is provided a method of controlling a fluorescent lamp, comprising, while the fluorescent lamp is in a quick-start mode, (a) determining a dimming level, (b) setting a boost level in dependence on the dimming level, and (c) controlling a lamp power in dependence on the dimming level and the boost level. So, by using the lamp current feedback system, the setpoint can be changed according to the required dimming. The resulting quick start mode does not suffer from the frequency mode instabilities mentioned earlier. Thus, in contrast to the prior art in which fixed operating frequency mode is forced during the quick start period, according to embodiments, fixed frequency is not forced, but instead a lamp current feedback system is enabled. With this system enabled, the setpoint can be changed according to the required dimming. Since a fixed low frequency mode is not required, frequency mode instabilities may be avoided.

Preferably, each of steps (a), (b) and (c) are repeated a plurality of times while the compact fluorescent lamp is in a quick-start mode. This provides for better compatibility with some types of step-dimmers, by avoiding unintentionally or unalterably disabling the boost feature.

Preferably, step (c) comprises controlling the lamp power to a quick-start set-point, which quick-start set-point is the product of the dimming level, the boost level and a normal operating set-point. By providing the quick-start set-point as a product of the dimming level, the boost level and the normal operating set-point (by simply multiplying the three values together), this provides for particularly convenient control algorithm.

In a preferred embodiment, step (b) comprises setting the boost level to unity if the dimming level is less than a dimming threshold, and setting the boost level to a value which is greater than unity if the dimming level is not less than the dimming threshold. Thus, by setting the boost to unity under certain conditions, quick-start conditions may be disabled during part or all of the quick-start mode period.

Alternatively and without limitation, in a more preferred embodiment step (b) comprises setting the boost level to unity if the dimming level is less than a dimming threshold minus a predetermined hysteresis offset, and setting the boost level to a value which is greater than unity if the dimming level is greater than the dimming threshold plus a further predetermined hysteresis offset. Beneficially, provision of such hysteresis, which may be symmetrical where the predetermined hysteresis offset is equal to the further predetermined hysteresis offset or asymmetrical if they are unequal, may be effective to prevent hopping between the two states in which the boost value is unity and greater than unity respectively.

Preferably, the lamp power is controlled by controlling a current through the lamp. Current control can be implemented by adapting the frequency of operation since in general a lower frequency operation results in higher power. Alternatively, other means of controlling the power, such as controlling the duty cycle of the power switches or controlling the supply or input voltage will be immediately apparent to the skilled user and are within the scope of the invention.

According to another aspect of the invention, there is provided a controller for a compact fluorescent lamp, the controller being adapted to operate according to a method as described above.

According to embodiments of the invention the controller comprises a boost connection, and is configured to receive information determinative of both the quick start power and a duration of the quick-start mode via the boost connection. Preferably, the controller is configured such that, in use, the information is provided by means of a network of one or more resistors and one or more capacitors connected to the boost connection. Thus, the start-up power and duration may be pre-determined, according to the type of lamp with which the controller is used.

Preferably, the network comprises a resistor for determining the quick-start power and a capacitor such that the duration of the quick-start mode is determined by means of a time constant associated with the resistor and the capacitor. Thus a single pin may be used for both the duration and power of the quick-start mode, which provides for a particularly simple implementation and frees up other pins of the controller for additional functionality where such is required.

According to another aspect of the invention, there is provided a compact fluorescent lamp comprising a controller adapted to operate according to a method as described above. Beneficially, such a lamp is compatible with pre-existing dimmer controllers of either phase-cut or step dimming types.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 shows a side view of a CFL lamp;

FIG. 2 is a schematic of some of the components of the CFL lamp;

FIG. 3 is a general state machine for the operation of a CFL lamp;

FIG. 4 is a view of part of the state machine of FIG. 3, modified according to a first embodiment of the present invention; and

FIG. 5 is a schematic showing a controller with a single-pin connection for determination of the boost level and duration.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments

### DETAILED DESCRIPTION OF EMBODIMENTS

In FIG. 1 is illustrated an example of a fluorescent lamp, begins compact fluorescent lamp (CFL) which is compatible with, and has almost exactly the same form as, a conventional screw-cap Incandescent lightbulb. An outer glass bowl 11 is supported in a sleeve 12, which lies above the screw cap 13, which provides for electrical connection directly from a mains supply to the lamp by means of thread 14 and tip 15.

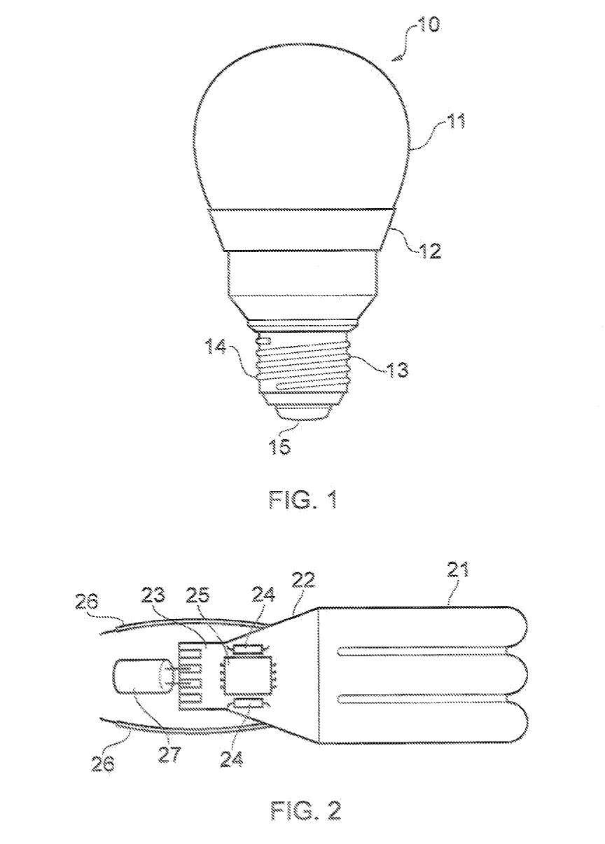

Major components within such a CFL luminaire are shown in FIG. 2. Within the outer glass bowl 11 lies a coiled or helical glass tube 21. Helical glass tube 21 is mounted on a sleeve 22, which is also used to mount one or more circuit boards 23. Only a single circuit board 23 is shown in the figure, however in alternative designs, a further circuit board, lying perpendicular to the plane of FIGURE, is also supported by the sleeve 22. Mounted on the circuit board 23, which may be a printed circuit board (PCB), are one or more discrete components 24, together with one or more integrated circuits 25 required to provide effective control for the CFL. Connection to the thread 14 and tip 15 of the screw 13, are provided by means of leads 26.

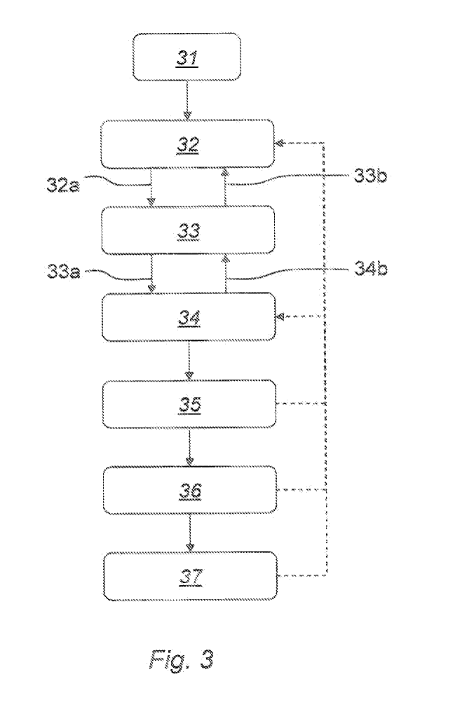

One means of operating a CFL as described above is illustrated in the FIG. 3. FIG. 3 shows a state machine of the general operation of a CFL lamp, including preheat, ignition, and Quick start states, as well as nominal operating state (which may also be referred to as a “burn” state).

The state machine operates by means of a state variable VDD, which corresponds to the supply voltage of the chip. Initially, in state 31, VDD is zero. The controller thence enters RESET state 32. If VDD>VDDreset, the state machine moves (via 32a) into START-UP state 33. Thence, if VDD>VDDstart, the state machine moves (via 33a) to PREHEAT state 34. In the PREHEAT state, the filaments are preheated to enable easier ignition and greatly improve the lifetime of the lamp. In this state, all the power converted by the driver goes to the filaments. Typically, this is significantly less than the lamp power during normal operation, so the current may be in the range of 300-400 mA. Usually this is accomplished by sweeping down the frequency from the startup frequency (in 100 kHz range) down to a value such as 70 kHz. Normally, either the preheat current is controlled or the preheat frequency is controlled.

After a predetermined preheating time, the state machine moves to IGNITION state 35. Whilst in IGNITION state 35 the operating frequency is decreased, creating a high voltage across the lamp to enable it to ignite and turn on. The high voltage is created through the resonant LC-circuit by approaching its resonant frequency. The ignition voltage is usually in the order of 600V, but depends on the tube diameter, temperature, gas filling, mercury pressure etc; typically thinner tubes require a higher voltage. The currents in the resonant circuit can reach up to perhaps 3 A. At the resonant frequency, the instantaneous power converted by the circuit will be very high, typically greater than 100 W.

From the IGNITION state 35, the CFL moves to QUICK START state 36. At the conclusion of the Quick Start time, which will be described in more detail hereinafter with reference to embodiments of the present invention, the CFL moves to a BURN state 37. Whilst in any of the ignition state 35, QUICK START state 36, or the BURN state 37, the machine tests if sufficient supply voltage (VDD) is still available, and if not, returns to the RESET state 32 or PRE-HEAT state 34 as appropriate. In burn mode, the lamp operates at a frequency of around 40-45 kHz. Depending on the circuit this is a fixed frequency, or it is variable, where the lamp current is controlled. The latter is much more suitable for dimming, because it can handle the inherent lamp instabilities at deep dimming levels. Lamp currents of course depend on the lamp power, but are usually in the 100-200 mA range for regular CFL-i, although there are exceptions where it can be greater than 300 mA

Note that not all CFL lamps initiate according the above sequence, and in particular some lamps operated without a separate PRE-HEAT state. For example, the frequency can be merely swept down, from approximately 100 kHz, through an IGNITION state and direct to the normal operating frequency. The invention is equally applicable to such initiation methods.

During a normal operating state of a CFL lamp (such as the BURN state 37 of FIG. 3 although it will be appreciated that the invention is not limited to any particular state machine or other operating method in general), the lamp may be controlled by a lamp current feedback system, relying on a reference current setpoint. For lamps with a dimming capability, the setpoint is adjusted according to the dimming level, according to:

setpoint=dimming*reference,

where “dimming” is a factor between 0-100% indicating the required brightness level on dimming and “reference” is the normal setpoint for a lamp which is not dimmed. Thus “dimming” can vary from 100% (which corresponds to normal lamp operation with no dimming), and a value between 0% and 100%. In the extreme case, where “dimming” is equal to 0%, the lamp is entirely extinguished. Thus it will be immediately apparent to the person skilled in the art that the value of “dimming” increases with increasing light level, and decreases with decreasing light level.

In embodiments of the invention, during a quick-start phase the lamp is operated in a fashion similar to its normal operating mode, that is, the frequency of operation is not fixed, but can vary whilst the lamp current is controlled through a feedback loop, but with the inclusion of a variable factor “boost”. Thus during the quick-start, the setpoint is adjusted according to:

setpoint=boost*dimming*reference,

where “boost” indicates the relative increase in lamp current during the quick start. Boost can therefore take on a value which is either unity (which corresponds to no increase in current and thus a disabled QUICK START), or is greater than unity (in which case the current through the lamp is scaled by the factor “boost”).

It will be readily appreciated by the skilled person that the two factors “boost” and “dimming” thus operate in combination during QUICK START—each acts to increase or reduce the lamp current. However, after the end of the QUICK START phase, when the lamp is in its normal operating state, or BURN mode, the factor boost is no longer used in the control system, whereas the factor “dimming” continues to be used to determine the degree of dimming required.

If the lamp is dimmed to a very low level then at the end of the quick start phase there can be significant, and rapid, change in lamp current. This change in lamp current is caused by the ending of the quick start period, at which moment the lamp current is changed from a boosted to a non-boosted level. As a result, the lamp might cool down locally and start varying in light output or possibly even extinguish, which is clearly undesirable to the user. The effect can be avoided by disabling the boost if the lamp is dimmed to a very low level. To check for this, an IF-THEN-ELSE test is adopted:

IF Dimming < Dimming Threshold THEN

Boost = 1.0x

ELSE

Boost > 1.0x (for example 2.0x)

END IF

Moreover, since some dimmers are available, which start from a low level on being switched on and then increase to a high level, it is possible that the above IF-THEN-ELSE test would result in disabling the boost under all conditions. To avoid this, the test can be repeatedly implemented during the quick start phase, for instance with the following pseudo-code:

WHILE Quick Start time has not elapsed
{

IF Dimming < Dimming Threshold THEN

Boost = 1.0x

ELSE

Boost > 1.0x (for example 2.0x)

END IF

}

As an additional preferred improvement, hysteresis can be added to prevent hopping, at the threshold, between the two states—that is, the QUICK START enabled state where boost>1, and the QUICK START disabled state where boost=1. The degree of hysteresis may be symmetrical or asymmetrical about the threshold. There is an additional advantage to this approach. By adjusting the threshold to a higher level, it is very easily implemented to disable quick start altogether when a phase cut dimmer is connected (regardless of how deep the lamp is dimmed).

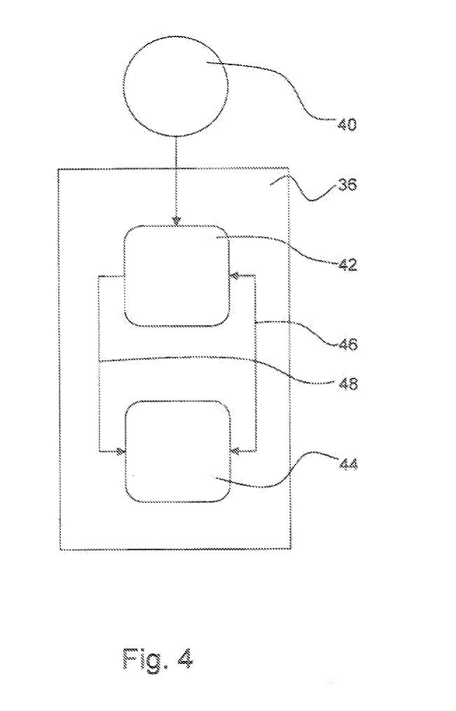

Methods according to embodiments of the invention affect the operation of the state machine whilst in the QUICK START state 36, as will now be described with reference to FIG. 4.

FIG. 4 shows a sub state machine illustrating a method according to an embodiment of the invention. The sub state machine shows a method of controlling a CFL whilst in a QUICK START 36, which may correspond to that shown above with reference to FIG. 3. The controller enters the QUICK START state 36 from an initial condition 40. Control moves to an ACTIVE state 42, at which a boost level is set to a predetermined value which is greater than unity, such as 2.0 for a boost to twice the unboosted current level. Boosting the current by a factor of two reduces the quick-start time by a factor which is approximately two. The state machine tests for the condition that

dimming<dimming threshold(−hysteresis)

If this condition is met, control moves by link 48, to an INACTIVE state 44, and the boost level is set to unity. Otherwise, the control stays in ACTIVE state 42, and the test is repeated.

Once in the INACTIVE state 44, the state machine tests for the condition:

dimming>dimming threshold(+hysteresis)

if this condition is met, controller moves by link 46, to the ACTIVE state 42, otherwise it repeats the test.

Thus, the state machine repeatedly tests for the condition appropriate to whichever sub-state it is in, and changes sub state when the appropriate test condition is met.

The state machine remains in QUICK START state 36, for a period which may be predetermined; alternatively, a maximum value only for the period may be predetermined, and the period terminated early by the control system meeting some other condition, such as the lamp temperature exceeding a predetermined temperature.

In order to limit or avoid completely any noticeable change to the illumination level at the end of the QuickStart period, the change from QUICK START state 36 to BURN state 37 may be effected by means of a transition phase. During the transition phase the boost level may be progressively reduced, from its value during quick-start, to unity (which is its value during the burn phase). Typically the boost is stepped through a series of up to 16 levels, over a period of up to or about 1 minute. During this transition, the same dimming level multiplier may be applied to the lamp power as during the QuickStart phase.

In summary, the QUICK START state 36 differs from prior art QUICK START states, in that it does not require a fixed operating frequency mode used in the prior art during the quick start period and it does enable a lamp current feedback system instead. With this system enabled, the setpoint can be changed according to the required dimming. Such a QUICK START does not suffer from the frequency mode instabilities discussed above.

In preferred embodiments of the invention, the controller is configured such that the duration of the QUICK-START mode, that is to say, the time during which, absent alteration of the QUICK-START duration due to under- or over-temperature conditions, the state machine is in the QUICK-START state is determined by means of external components. Similarly, the level of the boost during of the QUICK-START mode, that is to say, the power level, absent alteration of the QUICK-START power level due to under- or over-temperature conditions, the state machine is in the QUICK-START state is also determined by means of external components. The external components may be resistors and capacitors.

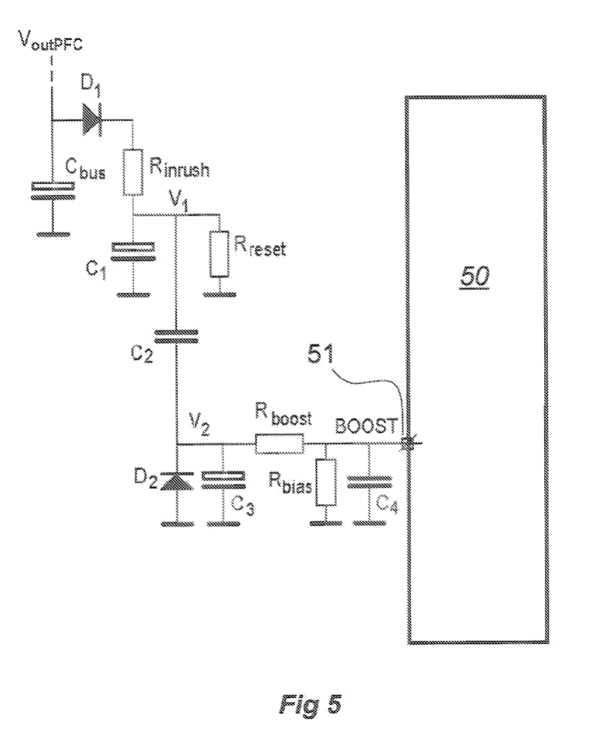

FIG. 5 shows a schematic of part of a controller, with a network of capacitors and resistors. Controller 50 has a “boost” connection pin 51, the input current in the boost pin is proportional to the increase of the lamp current. Resistor Rboost is connected between the pin 51 and ground, via a diode D2; to node V2 between Rboost and diode D2 is connected a first terminal of a second capacitor C2, the other terminal of which is connected to ground via a parallel arrangement of a resistor Rreset and a further capacitor C1. To node V1 between capacitor C2 and reset resistor Rreset is connected a further resistor Rinrush, the other terminal of which is grounded via a blocking diode D1 and further capacitor Cbus. Cbus and D1 are indirectly connected to the output of a PFC stage (at voltage VoutPFC) or directly to the rectified mains voltage.

The resistor Rboost determines the boost current. The duration of the boost period is determined by the time constant C3Rboost. The time constant C1Rreset determines the cooling down time constant and influences the boost at switching on of the lamp shortly after switching off of the lamp

From reading the present disclosure, other variations and modifications will be apparent to the skilled person. Such variations and modifications may involve equivalent and other features which are already known in the art of CFL control, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method of controlling a fluorescent lamp, comprising, while the compact fluorescent lamp is in a quick-start mode,
(a) determining a dimming level,
(b) setting a boost level in dependence on the dimming level, and
(c) controlling a lamp power in dependence on the dimming level and the boost level.

2. The method of claim 1, further comprising repeating each of steps (a), (b) and (c) a plurality of times while the compact fluorescent lamp is in the quick-start mode.

3. The method of claim 1, wherein step (c) comprises controlling the lamp power to a quick-start set-point, which quick-start set-point is a product of the dimming level, the boost level and a normal operating set-point.

4. The method of claim 1, wherein step (b) comprises setting the boost level to unity if the dimming level is less than a dimming threshold, and setting the boost level to a value which is greater than unity if the dimming level is not less than the dimming threshold.

5. The method of claim 1, wherein step (b) comprises setting the boost level to unity if the dimming level is less than a dimming threshold minus a predetermined hysteresis offset, and setting the boost level to a value which is greater than unity if the dimming level is greater than the dimming threshold plus a further predetermined hysteresis offset.

6. The method of claim 1 wherein the lamp power is controlled by controlling a current through the lamp.

7. A controller for a fluorescent lamp, the controller being adapted to operate according to a method as claimed in claim 1.

8. A controller according to claim 7, further comprising a boost connection, and configured to receive information determinative of both the boost level and a duration of the quick-start mode via the boost connection.

9. A controller according to claim 8 configured such that, in use, the information is provided by a network of at least one resistor and at least one capacitor connected to the boost connection.

10. A controller according to claim 8, wherein the network comprises a resistor for determining the boost level and a capacitor such that the duration of the quick-start mode is determined by a time constant associated with the resistor and the capacitor.

11. A fluorescent lamp comprising a controller adapted to operate according to a method as claimed in claim 1.
